(19) United States
(12) Patent Application Publication
(10) Pub. No.: US 2026/0217265 A1
(43) Pub. Date: Jul. 30, 2026

(54) VEHICLE ELECTRONIC CONTROL UNIT RESOURCE UTILIZATION DURING VEHICLE CONTROL

(71) Applicant: GM GLOBAL TECHNOLOGY OPERATIONS LLC, DETROIT, MI (US)

(72) Inventors: Wubing Qin, West Bloomfield, MI (US); Amirreza Mirbeygi Moghaddam, North York (CA); Jackson Barry McGrory, Toronto (CA); Jimmy Lu, Stouffville (CA); Reza Zarringhalam, Whitby (CA)

(21) Appl. No.: 19/039,301

(22) Filed: Jan. 28, 2025

(51) Int. Cl. B60W 50/06

(52) U.S. Cl. CPC B60W 50/06; B60W 2050/065; B60W 2710/20

(57) ABSTRACT

Examples described herein provide a method with electronic control unit resource monitoring and horizon adaptation during vehicle control. The method includes receiving data from a sensor of a vehicle. The method further includes determining a reference trajectory for the vehicle and a control horizon. The method further includes segmenting a discretization step into a plurality of steps. The method further includes converting continuous-time dynamics to discrete-time dynamics for one step of the plurality of steps. The method further includes iterating over the plurality of steps to generate discretized dynamics for the discretization step. The method further includes using the discretized dynamics in a model predictive controller to generate desired steering commands for the vehicle. The method further includes controlling the vehicle using the desired steering commands generated by the model predictive controller using the discretized matrix.

### BACKGROUND

The subject disclosure relates to vehicles, and in particular to vehicle electronic control unit resource utilization during vehicle control.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition (e.g., roadway signs, etc.), and/or the like, including combinations and/or multiples thereof. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), lidar device(s), and/or the like for perception tasks. Radar (radio detection and ranging) is a technology that uses radio waves to detect and determine the distance, speed, and angle of objects. Radar works by emitting radio signals that bounce off objects and return to the radar system, where the reflected waves are analyzed based on the amount of time and frequency change between emission and reception. The measured time can be used to determine the distance between the radar device and the detected object, while the measured frequency change in the carrier wave can be used to determine the speed difference using Doppler effect, which can be used when performing perception tasks.

Perception tasks can include one or more of object detection, classification, tracking, lane detection, road sign recognition, and obstacle avoidance. Perception tasks are particularly useful for an autonomous or semi-autonomous vehicle to provide the vehicle with real-time awareness of its environment to make safe and informed driving decisions. Images from the one or more cameras of the vehicle can also be used for detecting objects, tracking targets, and/or the like, including combinations and/or multiples thereof. Perception tasks are useful for implementing advanced driver assistance systems (ADASs).

The desire for precise vehicle control using ADASs is important for efficient operation of the vehicle.

### SUMMARY

In one embodiment, a computer-implemented method with electronic control unit resource monitoring and horizon adaptation during vehicle control is provided. The method includes receiving data from a sensor of a vehicle. The method further includes determining a reference trajectory for the vehicle and a control horizon. The method further includes segmenting a discretization step into a plurality of steps. The method further includes converting continuous-time dynamics to discrete-time dynamics for one step of the plurality of steps. The method further includes iterating over the plurality of steps to generate discretized dynamics for the discretization step. The method further includes using the discretized dynamics in a model predictive controller to generate desired steering commands for the vehicle. The method further includes controlling the vehicle using the desired steering commands generated by the model predictive controller using the discretized matrix.

In addition to one or more of the features described herein, or as an alternative, further embodiments of the method may include dynamically adjusting the control horizon based on available computational resources of an electronic control unit of the vehicle.

In addition to one or more of the features described herein, or as an alternative, further embodiments of the method may include that dynamically adjusting the prediction and control horizons includes monitoring central processing unit utilization and task execution times.

In addition to one or more of the features described herein, or as an alternative, further embodiments of the method may include that the discretized dynamics for the discretization step are generated using a scaling and squaring approach.

In addition to one or more of the features described herein, or as an alternative, further embodiments of the method may include that segmenting the discretization step into a plurality of steps is performed using the following equation:

$$h = \frac{T}{{2}^{N}}$$

where h is a time period of one step of the plurality of steps, T is a total time period of one discretization step, and N is an integer.

In addition to one or more of the features described herein, or as an alternative, further embodiments of the method may include that conversion from continuous-time dynamics to discrete-time dynamics for one step of the plurality of steps are generated using a bilinear transformation.

In addition to one or more of the features described herein, or as an alternative, further embodiments of the method may include that the continuous-to-discrete conversion is performed by discretizing the following equation for each step h of the plurality of steps:

$$\dot{x} = {A}_{c} x + {B}_{c} u$$

where x is the state vector, \dot{x} is the derivative of the state vector x with respect to time t, A_{c} is the continuous-time system matrix, B_{c} is the continuous-time input matrix, and u is the input vector.

In addition to one or more of the features described herein, or as an alternative, further embodiments of the method may include that the converting the continuous-time dynamics to discrete-time dynamics leads to the following equation:

$$x ( k + 1 ) = {A}_{d} x ( k ) + {B}_{d} u ( k )$$

where k is a discrete time index, A_{d} is a discretized system matrix using bilinear transformation, and B_{d} is a discretized input matrix using bilinear transformation.

In addition to one or more of the features described herein, or as an alternative, further embodiments of the method may include that a second iteration k+2 of the discretization is performed according to the following equation:

$$x ( k + 2 ) = {A}_{d} x ( k + 1 ) + {B}_{d} u ( k ) = {( {A}_{d} )}^{2} x ( k ) + ( {A}_{d} + I ) {B}_{d} u ( k )$$

where I is an identity matrix.

In addition to one or more of the features described herein, or as an alternative, further embodiments of the method may include that a third iteration k+4 of the discretizing is performed according to the following equation:

$$x ( k + 4 ) = {( {A}_{d} )}^{2} x ( k + 2 ) + ( {A}_{d} + I ) {B}_{d} u ( k ) = {( {A}_{d} )}^{4} x ( k ) + ( {( {A}_{d} )}^{2} + I ) ( {A}_{d} + I ) {B}_{d} u ( k ) .$$

In addition to one or more of the features described herein, or as an alternative, further embodiments of the method may include that a fourth iteration k+8 of the discretizing is performed according to the following equation:

$$x ( k + 8 ) = {( {A}_{d} )}^{4} x ( k + 4 ) + ( {( {A}_{d} )}^{2} + I ) ( {A}_{d} + I ) {B}_{d} u ( k ) = {( {A}_{d} )}^{8} x ( k ) + ( {( {A}_{d} )}^{4} + I ) ( {( {A}_{d} )}^{2} + I ) ( {A}_{d} + I ) {B}_{d} u ( k ) .$$

In another embodiment, a vehicle is provided. The vehicle includes a sensor, a vehicle plant, and a processing system that includes a memory having computer readable instructions and a processing device for executing the computer readable instructions. The computer-readable instructions control the processing system to perform operations for electronic control unit resource utilization during vehicle control. The operations include receiving data from the sensor of the vehicle. The operations further include determining a reference trajectory for the vehicle and a control horizon. The operations further include segmenting a discretization step into a plurality of steps. The operations further include converting continuous-time dynamics to discrete-time dynamics for one step of the plurality of steps. The operations further include iterating over the plurality of steps to generate discretized dynamics for the discretization step. The operations further include using the discretized dynamics in a model predictive controller to generate desired steering commands for the vehicle. The operations further include causing the vehicle plant to control the vehicle using the desired steering commands generated by the model predictive controller using the discretized matrix.

In addition to one or more of the features described herein, or as an alternative, further embodiments of the vehicle may include that the operations further include dynamically adjusting the control horizon based on available computational resources of an electronic control unit of the vehicle.

In addition to one or more of the features described herein, or as an alternative, further embodiments of the vehicle may include that dynamically adjusting the prediction and control horizons includes monitoring central processing unit utilization and task execution times.

In addition to one or more of the features described herein, or as an alternative, further embodiments of the vehicle may include that the discretized dynamics for the discretization step are generated using a scaling and squaring approach.

In addition to one or more of the features described herein, or as an alternative, further embodiments of the vehicle may include that the conversion from continuous-time dynamics to discrete-time dynamics for one step of the plurality of steps is generated using a bilinear transformation.

In another embodiment a computer program product is provided. The computer program product includes a set of one or more computer-readable storage media and program instructions, collectively stored in the set of one or more storage media, for causing a processor set to perform computer operations for electronic control unit (ECU) resource utilization while controlling a vehicle. The operations include initiating prediction and control horizons using nominal values. The operations further include monitoring ECU resources. The operations further include determining if a rate of change of task execution at the ECU exceeds a first threshold. The operations further include determining if a rate of change of CPU utilization at the ECU exceeds a second threshold. The operations further include detecting if a CPU task overrun at the ECU is present. The operations further include reducing the prediction and control horizons to generate reduced prediction and control horizons responsive to a determination that any of the rate of change of task execution exceeds the first threshold, the rate of change of CPU utilization exceeds the second threshold, or the CPU task overrun is present. The operations further include determining if the reduced prediction and control horizons are below a minimum acceptable threshold. The operations further include, responsive to determining that the reduced prediction and control horizons are not below the minimum acceptable threshold, continuing control operation. The operations further include, responsive to determining that the reduced prediction and control horizons are not below the minimum acceptable threshold, requesting escalation.

In addition to one or more of the features described herein, or as an alternative, further embodiments of the computer program product may include that reducing the prediction and control horizons includes decrementing the prediction and control horizons by a predefined step size to generate the reduced prediction and control horizons.

In addition to one or more of the features described herein, or as an alternative, further embodiments of the computer program product may include that requesting escalation includes generating an alert to a vehicle operator indicating that manual intervention is required.

In addition to one or more of the features described herein, or as an alternative, further embodiments of the computer program product may include that requesting escalation includes implementing an alternative control strategy to control the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A illustrates a vehicle with a processing system, a sensor, and a vehicle plant according to one or more embodiments;

FIG. 1B illustrates the processing system of FIG. 1A according to one or more embodiments;

FIG. 2 illustrates a block diagram of an ADAS controller, which is responsible for processing various inputs and generating control commands to manage operation of the vehicle of FIG. 1, according to one or more embodiments

FIG. 3 illustrates a flow diagram of a method for model predictive control-based vehicle control using a multi-step online discretization strategy on an electronic control unit (ECU) during vehicle control according to one or more embodiments;

FIG. 4 illustrates a flow diagram of a method for electronic control unit resource utilization monitoring and control horizon adaptation with feedback mechanism during vehicle control according to one or more embodiments; and

FIG. 5 illustrates a block diagram of a processing system for scenario-based engagement of a model predictive controller for controlling a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to vehicle electronic control unit resource utilization during vehicle control.

Vehicles may use advanced driver assistance systems (ADASs) to improve vehicle performance and enhance driving comfort by providing automating, adapting, or enhancing vehicle systems to provide better awareness, decision-making, and control.

One example of an ADAS is an adaptive cruise control (ACC) system, which automatically adjusts the velocity of a vehicle to maintain a safe following distance from its direct preceding vehicle. Another example of an ADAS is an automated lane change (ALC) system to cause the vehicle to perform a lane change. Another example of an ADAS is a front collision alert (FCA) system to generate an alert to an operator of the vehicle warning of a potential front collision. Another example of an ADAS is a collision imminent braking (CIB) system to apply brakes of the vehicle to reduce velocity of the vehicle. Another example of an ADAS is an automated evasive steering (AES) system to adjust the trajectory of the vehicle.

ADASs often utilize various sensors, including cameras, radar devices, and/or lidar devices, to perform perception tasks, such as object detection, classification, tracking, lane detection, road sign recognition, and obstacle avoidance. The data collected from these sensors enable vehicles to make real-time decisions, improving the overall driving experience and safety. Despite the advancements in ADAS, the precise control of vehicles remains a significant challenge. The computational demands of model predictive control (MPC) algorithms, which are often used in ADAS for motion planning and control, can be substantial. These algorithms require significant processing power to discretize continuous-time dynamics and generate control commands in real-time. In resource-constrained environments, such as embedded electronic control units (ECUs) often used in vehicles for ADAS and/or MPC, meeting these computational demands can be difficult, leading to potential delays, task overruns, and suboptimal control performance.

Existing solutions for vehicle control using MPC in ADASs often struggle with the high computational requirements, especially in embedded systems with limited processing capabilities. Existing discretization methods may not be efficient enough to handle the real-time demands of vehicle control, resulting in increased ECU throughput and potential task overruns. Additionally, the lack of a feedback mechanism to adapt the control strategy based on available ECU resources can lead to interruptions in control operations and reduced system reliability.

One or more embodiments described herein address these and other shortcomings by providing a fast, efficient, and accurate model predictive control strategy for embedded applications of automated driving. Such one or more embodiments introduces a novel plant modeling strategy that fits the model predictive controller within the constraints of an embedded ECU. By employing a multi-step discretization of the plant model, the one or more embodiments reduces the computational demand of the MPC algorithm, enabling real-time execution in resource-constrained environments. Furthermore, a feedback mechanism between ECU resource monitors and the ADAS control strategy can be implemented to provide uninterrupted operation by dynamically adapting the control and prediction horizons based on available resources. This real-time adaptation helps avoid task overruns and infeasible solutions, enhancing the overall performance and reliability of the vehicle control system.

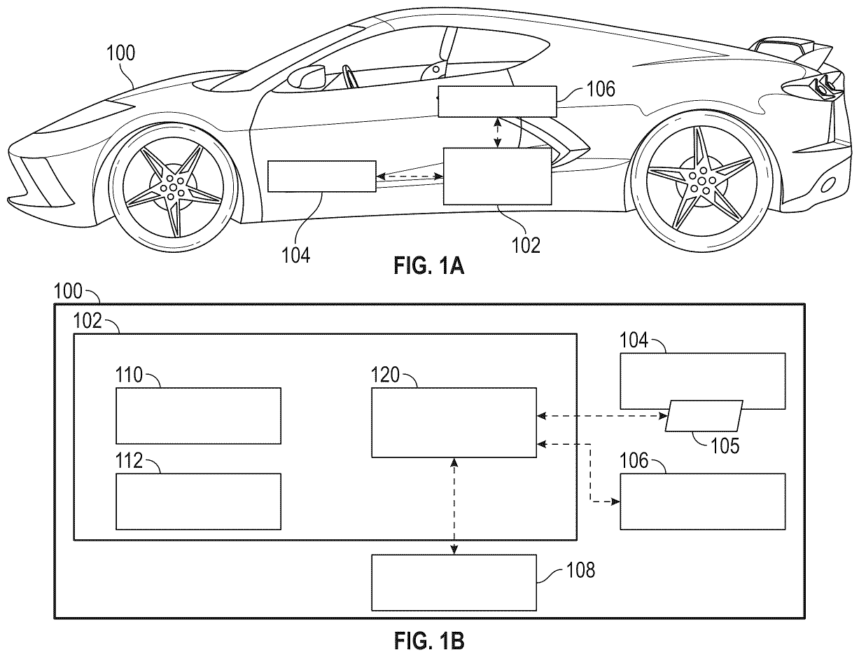

FIG. 1A shows a vehicle 100 with a processing system 102, a sensor 104, and a vehicle plant 106 according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. According to another embodiment, the vehicle 100 is an electric vehicle powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 includes an internal combustion engine (not shown) that provides electrical and/or mechanical energy for providing propulsion to the vehicle 100. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The processing system 102 is located within the vehicle and is responsible for managing and processing data collected by the sensor 104. The sensor 104 represents one or more sensors, which may vary in type. The sensor 104 may be any suitable sensor(s) and/or combination of sensors, such as a camera, a radar device, a lidar device, a proximity sensor, and/or the like, including combinations and/or multiples thereof. The arrows between the sensor 104 and the processing system 102 indicate the flow of data from the sensor 104 to the processing system 102, highlighting the interaction between these components. This setup enables the vehicle 100 to perform perception tasks, which can be used for autonomous driving for example, using the data collected by the sensor 104. According to one or more embodiments, the processing system 102 can be used to implement an active safety feature (e.g., an ADAS) and to control the vehicle 100 using the vehicle plant 106. The vehicle plant 106 is a collection of electromechanical components and subsystems within the vehicle 100 that are responsible for executing control commands and performing physical actions. This includes, but is not limited to, actuators, sensors, and control modules that manage various aspects of the operation of the vehicle 100, such as steering, braking, acceleration, and stability control. The vehicle plant 106 interacts with the processing system 102 to receive control signals generated by the processing system 102 and translates these signals into precise mechanical movements and adjustments for controlling the vehicle 100. This integration ensures that the vehicle 100 can respond accurately and efficiently to dynamic driving conditions, thereby enhancing the overall performance, reliability, and efficiency of the vehicle 100.

Further features and functions of the processing system 102, the sensor 104, and the vehicle plant 106 are now described with reference to FIG. 1B.

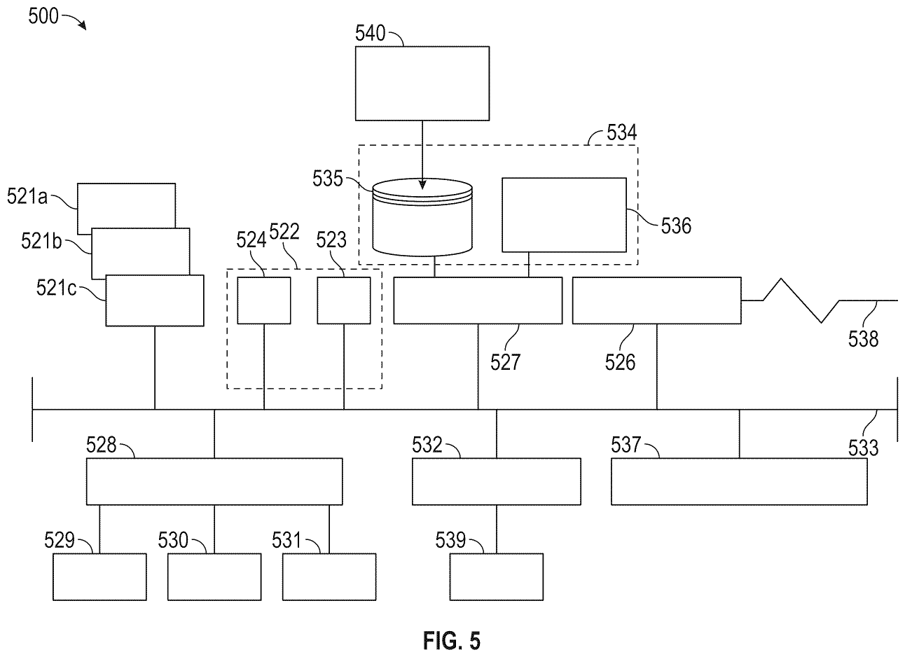

Particularly, FIG. 1B illustrates the processing system 102 of FIG. 1A according to one or more embodiments. According to one or more embodiments, the processing system 102 includes a processing device 110, a memory 112, and an ADAS control engine 120. It should be appreciated that the processing system 102 can be any device suitable for ADAS and/or performing model predictive control for controlling a vehicle. For example, the processing system 102 can be a device implemented in or otherwise associated with the vehicle 100, such as an electronic control unit (ECU) (also referred to as an electronic control module). As another example, the processing system 102 can be a smartphone, tablet computer, laptop computer, desktop computer, wearable computing device, and/or the like, including combinations and/or multiples thereof. As yet another example, the processing system 102 can be the processing system 500 of FIG. 5 and/or can include one or more components of the processing system 500 of FIG. 5.

The processing device 110 is responsible for executing instructions and managing the overall operation of the processing system 102. The processing device 110 can be any suitable processing circuitry for executing instructions and processing data. For example, the processing device 110 can be a microcontroller, microprocessor, application-specific integrated circuit (ASIC), or any other type of processing unit capable of handling the computational demands of the processing system 102. The processing device 110 is an example of one or more of the processing devices 521 of FIG. 5, as described in more detail herein.

The memory 112 stores data (e.g., data 105), computer-readable instructions, and algorithms useful for operation of the processing system 102. This may include real-time data processing, historical data analysis, and storage of firmware or software programs. The memory 112 is any suitable device for storing data, such as the data 105 received from the sensor 104, and/or instructions. For example, the memory 112 can be a combination of volatile memory (e.g., random access memory) and non-volatile memory (e.g., read-only memory, flash memory). The memory 112 is an example of one or more of the system memory 522, the random access memory 523, and/or the read-only memory 524 of FIG. 5, as described in more detail herein.

The processing system 102 receives data 105 (from the sensor 104) about the vehicle 100 (e.g., telemetry data about the vehicle) and/or about the environment in which the vehicle is operating (e.g., images of objects in the environment, point cloud data of objects in the environment, etc.). According to one or more embodiments, the data 105 can be images of a lane in which the vehicle 100 is traveling, including any lane markers (e.g., lane lines, turn indicators, etc.) of the lane. The data 105 can be useful, for example, for performing perception tasks, which in turn are used to control the vehicle using an ADAS.

The ADAS control engine 120 is responsible for managing and executing advanced driver assistance systems functionalities. The ADAS control engine 120 is designed to enhance vehicle performance and efficiency by automating, adapting, and/or enhancing various vehicle systems to provide better awareness, decision-making, and control.

The ADAS control engine 120 processes data (e.g., data 105) received from various sensors (e.g., the sensor 104), such as cameras, radar devices, and lidar devices, to perform perception tasks including object detection, classification, tracking, lane detection, road sign recognition, and obstacle avoidance. By analyzing this sensor data, the ADAS control engine 120 can generate real-time situational awareness of the environment in which the vehicle 100 operates.

One of the functions of the ADAS control engine 120 is to implement MPC algorithms for motion planning and control. The ADAS control engine 120 uses the data (e.g., data 105) from the sensors (e.g., sensor 104) to predict the future states of the vehicle 100 and optimize control inputs to achieve the desired trajectory. This involves calculating the optimal steering, acceleration, and braking commands to ensure the vehicle 100 follows the planned path while maintaining operating efficiency, reliability, and comfort.

The ADAS control engine 120 also includes mechanisms for real-time adaptation of control parameters based on available computational resources of the processing system 102, which may be or include an ECU. This includes dynamically adjusting the prediction and control horizons to avoid task overruns and ensure uninterrupted operation. The ADAS control engine 120 monitors various resource metrics, such as CPU utilization and task execution times, and adapts the ADAS control strategy accordingly to maintain optimal performance of the processing system 102 (e.g., an ECU).

The ADAS control engine 120 controls the vehicle 100 by sending commands to the vehicle plant 106, which includes electromechanical components and subsystems responsible for executing these commands. The commands from the ADAS control engine 120 may include steering angles, acceleration, and braking commands, among others. The ADAS control engine 120 dynamically adjusts these commands based on the current driving conditions and available ECU resources, ensuring that the vehicle 100 operates efficiently. The commands are then transmitted to the vehicle plant 106, where actuators and control modules translate them into physical actions, such as turning the steering wheel, applying the brakes, or adjusting the throttle. This seamless integration between the ADAS control engine 120 and the vehicle plant 106 enables the vehicle 100 to respond quickly and accurately to dynamic driving environments, enhancing overall performance and operation of the vehicle 100.

In summary, the ADAS control engine 120 is a sophisticated module within the processing system 102 that integrates sensor data processing, perception tasks, and model predictive control to enhance vehicle efficiency and performance. The ADAS control engine 120 also ensures real-time, accurate control of the vehicle 100 by dynamically adapting to resource constraints and optimizing control inputs based on the current driving conditions.

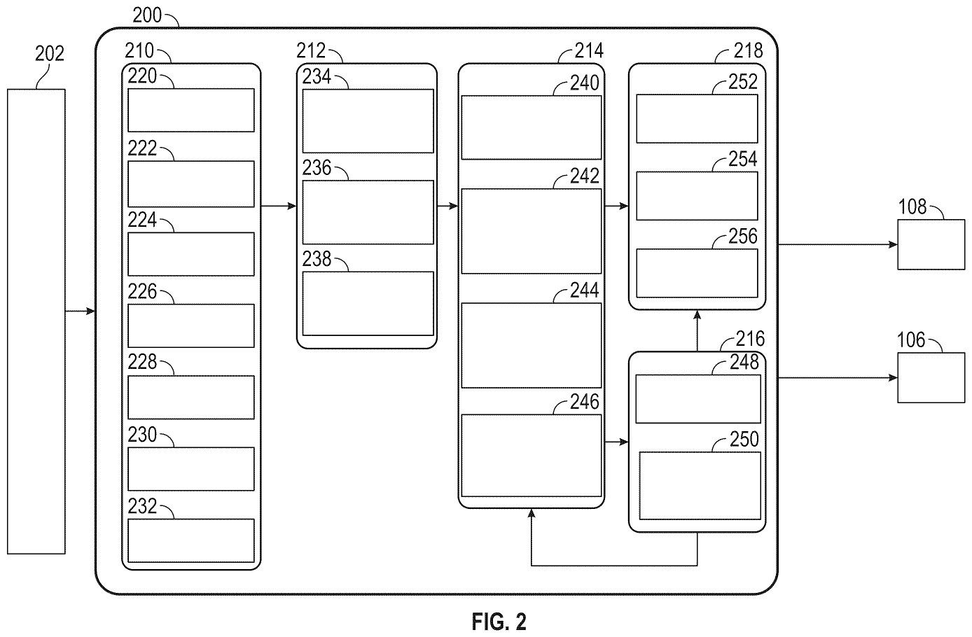

FIG. 2 illustrates a block diagram of an ADAS controller 200, which is responsible for processing various inputs and generating control commands to manage operation of the vehicle 100 according to one or more embodiments. The ADAS controller 200 is one possible implementation of the ADAS control engine 120, although modifications are possible in other embodiments. The ADAS controller 200 is designed to enhance vehicle performance and operation by automating, adapting, or enhancing various vehicle systems.

The diagram of FIG. 2 is divided into several functional blocks, each representing different stages of data processing and control within the ADAS controller 200. The inputs 202 block represents the various inputs received by the ADAS controller 200, including data from one or more sensors (e.g., sensor 104), such as cameras, radar, lidar, and other relevant sources that provide real-time information about the vehicle's environment and driver actions.

Block 210 represents pre-processing, which can include several sub-components responsible for processing different types of driver inputs and environmental data (e.g., the inputs 202), such as process driver pedal input 220 (e.g., processes inputs from the driver's pedal actions), process driver steering input 222 (e.g., processes input from the driver's steering actions), process turn switch input 224 (e.g., processes input from the turn signal switch), process driver attention state 226 (e.g., monitors and processes the driver's attention state), vehicle path prediction 228 (e.g., predicts the vehicle's path based on current inputs and conditions), object fusion 230 (e.g., fuses data from multiple sensors and tracks objects around the vehicle), and lane fusion 232 (e.g., fuses data to detect and track lane markings).

Block 212 represents motion planning, which can include components for planning the mission of the vehicle 100 based on the processed inputs (from block 210). More particularly, the motion planning of block 212 can include process enablement conditions 234 (e.g., determines whether conditions are suitable for enabling ADAS), generate obstacle grid 236 (e.g., creates a grid map of obstacles around the vehicle), and generate super cruise and/or assisted evasive steering (AES) trajectory 238 (e.g., generates trajectories for super cruise and/or AES).

Block 214 represents MPC-based control. Particularly, this block focuses on model predictive control and includes plant model and real-time discretization 240 (e.g., models vehicle's dynamics and discretizes them in real-time or near-real time for MPC); input/output weights, references, and constraints 242 (e.g., defines the weights, references, and constraints for MPC optimization); real-time prediction and control horizon modifiers 244 (e.g., defines and/or adjusts the prediction and control horizons based on available resources of the processing system 102 (e.g., ECU)); and MPC optimization and desired steering command 246 (e.g., optimizes control inputs and generates the desired steering commands).

Block 216 represents a resource feedback mechanism that monitors the ECU resources (e.g., the processing system 102) and includes ECU resource monitors 248 (e.g., monitors overall resource usage of the processing system 102 (e.g., ECU)) and ECU task execution monitors 250 (e.g., monitors the execution of tasks within the processing system 102 (e.g., ECU)).

Block 218 provides for vehicle control, which includes the final stages of command processing and vehicle operation monitoring, including command processing 252 (e.g., processes the optimized control commands and generates actuator commands for execution), safety monitors 254 (e.g., monitors the safety of the control commands/actions), and escalation request 256 (e.g., generates requests for escalation if the control actions cannot be safely executed). The outputs from the ADAS controller 200 are sent to the vehicle plant 106, which includes the actuators responsible for steering, braking, and propulsion. Additionally, the ADAS controller 200 can provide information to an operator of the vehicle 100 by providing a human-machine interface (HMI) via a display 108 to provide feedback to the operator.

Overall, FIG. 2 provides an overview of the ADAS controller 200, detailing the flow of data from initial sensor inputs through various stages of processing, motion planning, model predictive control, resource monitoring, and final command execution to ensure optimized and efficient operation of the vehicle 100.

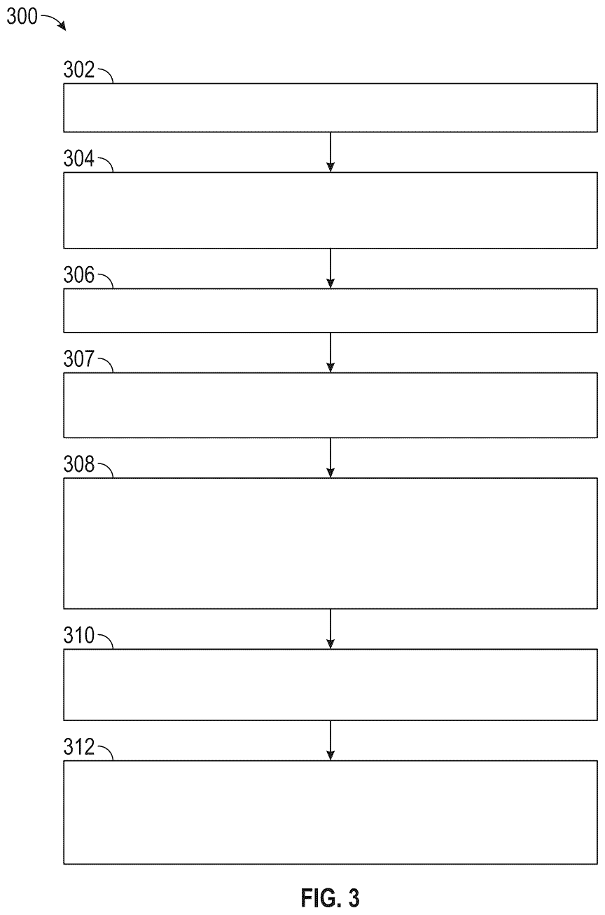

FIG. 3 illustrates a flow diagram of a method 300 for MPC-based vehicle control using a multi-step online discretization strategy on an electronic control unit during vehicle control according to one or more embodiments. The method 300 can be implemented using any suitable system or device. For example, the method 300, and its real-time discretization method, can be implemented using the processing system 102 of FIGS. 1A and 1B, by the processing system 500 of FIG. 5, and/or the like, including combinations and/or multiples thereof. The method 300 is now described with reference to at least portions of FIGS. 1A, 1B, and 2 but is not so limited.

Block 302 initiates the method 300 by receiving data (e.g., data 105) from a sensor (e.g., sensor 104) of a vehicle (e.g., vehicle 100). The sensor can be any suitable sensor, such as a camera, radar device, lidar device, or a combination thereof. The data received from the sensor provides real-time (or near-real time) information about the vehicle's environment, driver actions, and/or the like, including combinations and/or multiples thereof. This data is used for performing perception tasks, which are used to control the vehicle using an ADAS. For example, the processing system 102 manages and processes the data received from the sensor 104. The data 105 from the sensor 104 can include images of a lane in which the vehicle 100 is traveling, including any lane markers, objects in the environment, and other relevant information.

Block 304 involves determining a reference trajectory for the vehicle 100 and a control horizon given a discretization step (e.g., multiples of discretization step to predict for the future). The trajectory is the planned path that the vehicle 100 will follow, which is determined based on the data received from the sensor 104 and processed by the ADAS control engine 120. The control horizon refers to the future time span over which the MPC-based control (block 214 of FIG. 2) optimizes the control inputs to the vehicle 100.

Block 306 involves segmenting the single discretization step into a plurality of steps to facilitate the MPC optimization process. This segmentation allows the MPC-based control (block 214 of FIG. 2) to obtain accurately discretized dynamics, which is useful for accurate control command generation. By breaking down the typically-large discretization step into smaller steps, the MPC-based control (block 214 of FIG. 2) can iteratively calculate the optimal control inputs over the control horizon based on accurately discretized dynamics for each discretization step, which is iteratively calculated from the discretized dynamics of these smaller steps, ensuring real-time performance and accuracy. For example, the plurality of steps can be determined as follows:

$$h = \frac{T}{{2}^{N}}$$

where h is the time period of one step of the plurality of steps, T is the total time period of one discretization step, and N is an integer.

Block 307 involves converting continuous-time dynamics to discrete-time dynamics for one step of the plurality of steps (e.g., h) from block 306. To characterize the dynamics, the state vector represents the current state of the vehicle 100, including variables such as position, velocity, and orientation. The continuous-time dynamic refers to the relation of how the change rate of state is affected by the current state and system input, while the analogous discrete-time dynamics refer to how the next state is affected by the current state and current input.

An example of performing the continuous-to-discrete (C2D) conversion is now described. The C2D conversion is performed by discretizing the following continuous-time dynamics for each step h of the plurality of steps:

$$\dot{x} = {A}_{c} x + {B}_{c} u$$

where x is the state vector, \dot{x} is the derivative of the state vector x with respect to time t, A_{c} is the continuous-time system matrix, B_{c} is the continuous-time input matrix, and u is the input vector. Performing C2D conversion results in the following discrete-time dynamics:

$$x ( k + 1 ) = {A}_{d} x ( k ) + {B}_{d} u ( k )$$

where k is the discrete time index (e.g., x(k) refers to x(t) at time t=k×h), A_{d} is the discretized system matrix, and B_{d} is the discretized input matrix.

In this embodiment, the C2D conversion is performed using bilinear transformation (BT) (also referred to as (1, 1)-Pade approximation); however, in other embodiments, the C2D conversion can be performed using other suitable techniques, such as backward Euler integration, forward Euler integration, Taylor series, and/or the like, including combinations and/or multiples thereof. Although various discretization approaches can be used, bilinear transformation provides advantages over existing approaches in that it works well at all velocities, the step size need not be small due to cubic accuracy, and pre-computation can be used to improve efficiency.

According to one or more embodiments, C2D conversion is performed using bilinear transformation according to the following equations:

$${A}_{d}^{B T} = {( I - \frac{h}{2} {A}_{c} )}^{- 1} ( I + \frac{h}{2} {A}_{c} )$$

$${B}_{d}^{B T} = {( I - \frac{h}{2} {A}_{c} )}^{- 1} {B}_{c} h$$

where

$${A}_{t}^{BD}$$

is one embodiment of A_{d} using bilinear transformation, and

$${B}_{d}^{B T}$$

is one embodiment of B_{d} using bilinear transformation. Discretization using bilinear transformation, for example, improves model accuracy significantly (e.g., greater than two orders of magnitude accuracy), leading to improved MPC performance in real-time (or near-real-time).

Block 308 involves generating discretized dynamics for the discretization step (e.g. T) by iteratively propagating the discretized dynamics for each of the plurality of steps from block 307. The discretization process converts the continuous-time dynamics of the vehicle into a discrete-time representation, which is more suitable for real-time computation on resource-constrained embedded ECUs. The discretized dynamics are obtained using a “scaling and squaring” approach which is described in more detail herein. In this approach, the iteration at block 308 is performed by doubling the step for the next step (e.g., 1, 2, 4, 8, 16, . . . , 2^{N}). It should be appreciated that the step is doubled but the matrices are squared, which is why this approach is referred to as a “scaling and squaring” approach.

The discretization for a single discretization step is performed iteratively for N times (e.g., 2^{N} steps) after C2D conversion for a single of step of the plurality of steps, in a process referred to as “scaling and squaring.” In a first iteration, for k+1, the discretization is performed according to the aforementioned C2D conversion equation:

$$x ( k + 1 ) = {A}_{d} x ( k ) + {B}_{d} u ( k ) .$$

For a second iteration, for k+2, the discretization is performed according to the following equation:

$$x ( k + 2 ) = {A}_{d} x ( k + 1 ) + {B}_{d} u ( k ) = {( {A}_{d} )}^{2} x ( k ) + ( {A}_{d} + I ) {B}_{d} u ( k )$$

where I is the identity matrix.

For a third iteration, for k+4, the discretization is performed according to the following equation:

$$x ( k + 4 ) = {( {A}_{d} )}^{2} x ( k + 2 ) + ( {A}_{d} + I ) {B}_{d} u ( k ) = {( {A}_{d} )}^{4} x ( k ) + ( {( {A}_{d} )}^{2} + I ) ( {A}_{d} + I ) {B}_{d} u ( k ) .$$

For a fourth iteration, for k+8, the discretizing is performed according to the following equation:

$$x ( k + 8 ) = {( {A}_{d} )}^{4} x ( k + 4 ) + ( {( {A}_{d} )}^{2} + I ) ( {A}_{d} + I ) {B}_{d} u ( k ) = {( {A}_{d} )}^{8} x ( k ) + ( {( {A}_{d} )}^{4} + I ) ( {( {A}_{d} )}^{2} + I ) ( {A}_{d} + I ) {B}_{d} u ( k ) .$$

Thus, using this approach, the number of iterations is reduced significantly from

$$\frac{T}{h} to {log}_{2} \frac{T}{h} .$$

As an example, consider the following pseudo-code describing this process:

$$for k = 1 : N$$

$${B}_{d} = ( {A}_{d} + I ) {B}_{d}$$

$${A}_{d} = {A}_{d} {A}_{d}$$

According to one or more embodiments, the system matrix A_{c} for the continuous-time physical system can be made block upper triangular (e.g., the elements on the lower left corner of the matrix are all zeros) by properly defining state vectors (e.g., typically in the order of position states, velocity states, acceleration states, etc.). This property is preserved in the corresponding system matrix A_{d} for the discretized dynamics and the matrix squaring calculation. Thus, in the matrix squaring process described herein, it is used to update the non-zero elements of the matrix without updating the “zero” elements in the lower left corner since the true results are already known beforehand. Also, when updating these non-zero elements, operations of addition and multiplication of these “zero” elements can be skipped. This improves the efficiency and accuracy (computer representation of zero has some underlying machine errors) of the iterative discretizing by not expending ECU computational resources on zero elements.

With continued reference to FIG. 3, block 310 involves using the discretized dynamics to generate desired steering commands for the vehicle. The MPC optimization process uses the discretized dynamics to calculate the optimal steering angles, acceleration, and braking commands for the vehicle 100 to follow the planned trajectory. The desired steering commands are generated based on the predicted future states of the vehicle 100 and the cost function with predefined weights, references, and constraints. The ADAS control engine 120 processes these commands and sends them to the vehicle plant 106, which includes the actuators responsible for executing the control actions.

Block 312 involves controlling the vehicle using the desired steering commands generated using the discretized matrix. The ADAS control engine 120 sends the optimized control commands to the vehicle plant 106, where actuators and control modules translate them into physical actions, such as turning the steering wheel, applying the brakes, adjusting the throttle, and/or the like, including combinations and/or multiples thereof. The vehicle plant 106 executes these commands to ensure that the vehicle 100 follows the planned trajectory while maintaining operating efficiency, reliability, and comfort. The ADAS control engine 120 continuously monitors the performance of the vehicle 100 and available ECU resources, dynamically adjusting the control strategy to avoid task overruns and ensure uninterrupted operation.

Additional processes also may be included, and it should be understood that the processes depicted in FIG. 3 represent illustrations, and that other processes may be added, or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processing device 110 of FIG. 1B, the processor(s) 521 of FIG. 5, and/or the like, including combinations and/or multiples thereof) of a computing system (e.g., the processing system 102 of FIGS. 1A and 1B, the processing system 500 of FIG. 5, and/or the like, including combinations and/or multiples thereof), cause the processor to perform the processes described herein.

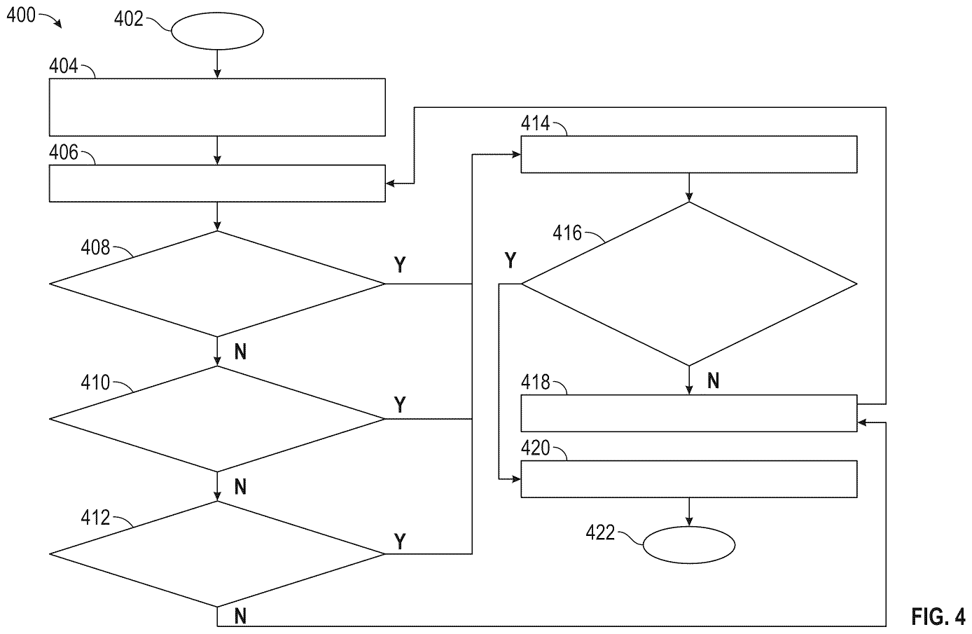

FIG. 4 illustrates a flow diagram of a method 400 for ECU resource utilization monitoring and control horizon adaptation with feedback mechanism during vehicle control according to one or more embodiments. The method 400 can be implemented using any suitable system or device. For example, the method 400, and its steps, can be implemented using the processing system 102 of FIGS. 1A and 1B, by the processing system 500 of FIG. 5, and/or the like, including combinations and/or multiples thereof. The method 400 provides for efficient and reliable operation of the vehicle 100 by dynamically adjusting the prediction and control horizons used for autonomous and/or semi-autonomous control of the vehicle 100 based on available ECU resources. According to one or more embodiments, the ECU described in FIG. 4 is an example implementation of the processing system 102 of FIGS. 1A and 1B. That is, the processing system 102 represents an ECU, but it should be appreciated that the method 400 may be implemented for monitoring any suitable type of controller, device, or system that may be used to control one or more aspects of a vehicle. The method 400 is now described with reference to at least portions of FIGS. 1A, 1B, and 2 but is not so limited.

The method 400 begins at block 402, where the method 400 starts. At block 404, the prediction and control horizons are initialized using nominal values.

The prediction horizon refers to the future time span over which the MPC-based control (block 214 of FIG. 2) predicts the behavior of the vehicle 100. It is the number of discrete time steps into the future that the MPC-based control (block 214 of FIG. 2) considers when forecasting the vehicle's state and performance. The prediction horizon enables the MPC-based control (block 214 of FIG. 2) to anticipate future events and make informed decisions to optimize the trajectory of the vehicle 100 and control actions. A longer prediction horizon provides a relatively more comprehensive view of the future but utilizes relatively more computational resources, while a shorter prediction horizon reduces computational demand but may result in relatively less optimal control decisions.

The control horizon refers to the future time span over which the MPC-based control (block 214 of FIG. 2) optimizes the control inputs to the vehicle 100. It is the number of discrete time steps into the future that the MPC-based control (block 214 of FIG. 2) considers when determining the optimal control actions to achieve the desired vehicle behavior. The control horizon may be shorter than or equal to the prediction horizon in one or more embodiments. The control horizon defines the duration over which the control inputs are actively adjusted to influence the trajectory of the vehicle. A longer control horizon enables relatively more gradual and smooth control actions, while a shorter control horizon may result in relatively more immediate and aggressive adjustments.

The nominal values represent the default lengths of the prediction and control horizons that are typically used under normal operating conditions and may be based on various characteristics of the vehicle (e.g., weight, mass moment of inertia, discretization step, accuracy requirement of control commands, designated computing resources, and/or the like, including combinations and/or multiples thereof) and/or operating conditions (e.g., speed, road type, weather, and/or the like, including combinations and/or multiples thereof).

At block 406, the method 400 involves monitoring the ECU resources of the vehicle 100. This monitoring includes tracking various metrics, such as task execution time (e.g., duration for a computational task to complete its processing), central processing unit (CPU) utilization (e.g., percentage of CPU's capacity that is being used to execute task(s) at a particular time), the occurrence of task overruns (e.g., situations where a computational task exceeds its allocated execution time, potentially leading to delays or failures in completing subsequent tasks within a desired time frame), and/or the like, including combinations and/or multiples thereof. The goal is to ensure that the ECU has sufficient resources to perform the necessary computations for vehicle control.

The method 400 then proceeds to decision block 408, where it is determined whether the rate of change of task execution exceeds a predefined threshold (e.g., a first threshold). If the rate of change of task execution exceeds the threshold, the method 400 moves to block 414. If not, the method 400 proceeds to decision block 410.

At decision block 410, the method 400 checks whether the rate of change of CPU utilization exceeds a predefined threshold (e.g., a second threshold). If the rate of change of CPU utilization exceeds the threshold, the method 400 moves to block 414. If not, the method proceeds to decision block 412.

At decision block 412, the method 400 determines whether a CPU task overrun is detected. If a CPU task overrun is detected, the method 400 moves to block 414. If no task overrun is detected, the method 400 loops back to block 418 to continue control operations.

At block 414, if any of the conditions in decision blocks 408, 410, or 412 are met, the method 400 reduces the prediction and control horizons. According to one or more embodiments, reducing the prediction and control horizons includes decrementing the prediction and control horizons by a predefined step size to generate the reduced prediction and control horizons. This reduction is performed to decrease the computational load on the ECU, ensuring that the control tasks for controlling the vehicle 100 can be completed within the available resources.

The method 400 then proceeds to decision block 416, where it is determined whether the reduced prediction and control horizons are below a minimum acceptable threshold. If the reduced prediction and control horizons are not below the minimum acceptable threshold, the method 400 continues control operation of the vehicle 100 at block 418. If the reduced prediction and control horizons are below the minimum acceptable threshold, the method 400 moves to block 420.

At block 420, the method 400 requests escalations. According to one or more embodiments, an escalation involves implementing an alternative control strategy to ensure the continued safe operation of the vehicle. The alternative control strategy may include switching to a simpler control algorithm or predefined fallback maneuvers. Additionally or alternatively, alerts may be generated to inform a vehicle operator of the need for manual intervention.

Finally, the method 400 ends at block 422.

Overall, FIG. 4 provides a detailed flowchart of a method 400 for dynamically adjusting the prediction and control horizons based on ECU resource availability, ensuring efficient and reliable vehicle control of the vehicle 100.

Additional processes also may be included, and it should be understood that the processes depicted in FIG. 4 represent illustrations, and that other processes may be added, or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processing device 110 of FIG. 1B, the processor(s) 521 of FIG. 5, and/or the like, including combinations and/or multiples thereof) of a computing system (e.g., the processing system 102 of FIGS. 1A and 1B, the processing system 500 of FIG. 5, and/or the like, including combinations and/or multiples thereof), cause the processor to perform the processes described herein.

One or more embodiments offer significant technical benefits. For example, one or more embodiments described herein offer significant benefits in terms of vehicle functioning and the functioning of the processing system, such as the ECU. These benefits are realized through the integration of advanced driver assistance systems and model predictive control strategies, which enhance the overall performance, safety, and efficiency of the vehicle.

One or more embodiments enable precise and real-time control of the vehicle by leveraging data from various sensors, such as cameras, radar, and lidar. This data is used to perform perception tasks, including object detection, lane tracking, and obstacle avoidance, which are critical for safe and efficient vehicle operation. By implementing MPC algorithms, one or more embodiments can predict the future states of the vehicle and optimize control inputs to follow a desired trajectory. This results in smoother and more accurate steering, acceleration, and braking actions, enhancing the vehicle's stability and responsiveness. Additionally, one or more embodiments provide the ability to dynamically adjust the prediction and control horizons based on real-time conditions, which ensures that the vehicle can adapt to changing environments and maintain optimal performance.

The processing system, including the ECU, benefits from the efficient utilization of computational resources through the described plant modeling strategy and multi-step discretization of the plant model. By reducing the computational demand of the MPC algorithm, one or more embodiments enables real-time (or near-real-time) execution in resource-constrained environments. The feedback mechanism between ECU resource monitors and the ADAS control strategy ensures uninterrupted operation by dynamically adapting the control and prediction horizons based on available resources. This real-time adaptation helps avoid task overruns and infeasible solutions, enhancing the overall reliability and robustness of the vehicle control system. Furthermore, one or more embodiments provides the ability to monitor various ECU resource metrics, such as CPU utilization and task execution times, which allows for proactive adjustments to the control strategy, ensuring that the ECU operates within its capacity and maintains optimal performance without undue or undesirable performance degradation, which may cause the vehicle to become partially or wholly inoperable.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. In examples, processing system 500 has one or more central processing units (referred to also as “processors” or “processing resources” or “processing devices”) 521a, 521b, 521c, etc. (collectively or generically referred to as processor(s) 521 and/or as processing device(s) 521). In aspects of the present disclosure, each processor 521 can include a reduced instruction set computer (RISC) microprocessor. Processors 521 are coupled to a system memory 522 and/or various other components via a system bus 533. The system memory 522 can include one or more temporary and/or persistent memory devices, such as a random access memory (RAM) 523, a read-only memory (ROM) 524, and/or the like, including combinations and/or multiples thereof. The system bus 533 may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 535 and/or a storage device 536 or any other similar component. I/O adapter 527, hard disk 535, and storage device 536 are collectively referred to herein as mass storage 534. Operating system 540 for execution on processing system 500 may be stored in mass storage 534. The network adapter 526 interconnects system bus 533 with an outside network 538 enabling processing system 500 to communicate with other such systems.

A display (e.g., a display monitor) 539 is connected to system bus 533 by display adapter 532, which may include a graphics adapter to improve the performance of graphics intensive applications and a video controller. In one aspect of the present disclosure, adapters 526, 527, and/or 532 may be connected to one or more I/O buses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit.

In some aspects of the present disclosure, processing system 500 includes a graphics processing unit (GPU) 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing and has a highly parallel structure that makes it more effective than general-purpose CPUs for algorithms where processing of large blocks of data is done in parallel.

Thus, as configured herein, processing system 500 includes processing capability in the form of processors 521, storage capability including the system memory 522 and mass storage 534, input means such as keyboard 525 and mouse 530, and output capability including speaker 531 and display 539. In some aspects of the present disclosure, a portion of system memory 522 and mass storage 534 collectively store the operating system 540 to coordinate the functions of the various components shown in processing system 500.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method with electronic control unit resource monitoring and horizon adaptation during vehicle control, the method comprising:
receiving data from a sensor of a vehicle;
determining a reference trajectory for the vehicle and a control horizon;
segmenting a discretization step into a plurality of steps;
converting continuous-time dynamics to discrete-time dynamics for one step of the plurality of steps;
iterating over the plurality of steps to generate discretized dynamics for the discretization step;
using the discretized dynamics in a model predictive controller to generate desired steering commands for the vehicle; and
controlling the vehicle using the desired steering commands generated by the model predictive controller using the discretized matrix.

2. The computer-implemented method of claim 1, further comprising dynamically adjusting the control horizon based on available computational resources of an electronic control unit of the vehicle.

3. The computer-implemented method of claim 2, wherein dynamically adjusting the control horizon includes monitoring central processing unit utilization and task execution times.

4. The computer-implemented method of claim 1, wherein the discretized dynamics for the discretization step are generated using a scaling and squaring approach.

5. The computer-implemented method of claim 1, wherein segmenting the discretization step into a plurality of steps is performed using the following equation:
$$h = \frac{T}{{2}^{N}}$$
where h is a time period of one step of the plurality of steps, T is a total time period of one discretization step, and N is an integer.

6. The computer-implemented method of claim 1, wherein conversion from continuous-time dynamics to discrete-time dynamics for one step of the plurality of steps are generated using a bilinear transformation.

7. The computer-implemented method of claim 6, wherein the continuous-to-discrete conversion is performed by discretizing the following equation for each step h of the plurality of steps:
$$\dot{x} = {A}_{c} x + {B}_{c} u$$
where x is the state vector, \dot{x} is the derivative of the state vector x with respect to time t, A_{c} is the continuous-time system matrix, B_{c} is the continuous-time input matrix, and u is the input vector.

8. The computer-implemented method of claim 6, wherein the converting the continuous-time dynamics to discrete-time dynamics leads to the following equation:
$$x ( k + 1 ) = {A}_{d} x ( k ) + {B}_{d} u ( k )$$
where k is a discrete time index, A_{d} is a discretized system matrix using bilinear transformation, and B_{d} is a discretized input matrix using bilinear transformation.

9. The computer-implemented method of claim 4, wherein a second iteration k+2 of the discretization is performed according to the following equation:
$$x ( k + 2 ) = {A}_{d} x ( k + 1 ) + {B}_{d} u ( k ) = {( {A}_{d} )}^{2} x ( k ) + ( {A}_{d} + I ) {B}_{d} u ( k )$$
where I is an identity matrix.

10. The computer-implemented method of claim 4, wherein a third iteration k+4 of the discretizing is performed according to the following equation:
$$x ( k + 4 ) = {( {A}_{d} )}^{2} x ( k + 2 ) + ( {A}_{d} + I ) {B}_{d} u ( k ) = {( {A}_{d} )}^{4} x ( k ) + ( {( {A}_{d} )}^{2} + I ) ( {A}_{d} + I ) {B}_{d} u ( k ) .$$

11. The computer-implemented method of claim 4, wherein a fourth iteration k+8 of the discretizing is performed according to the following equation:
$$x ( k + 8 ) = {( {A}_{d} )}^{4} x ( k + 4 ) + ( {( {A}_{d} )}^{2} + I ) ( {A}_{d} + I ) {B}_{d} u ( k ) = {( {A}_{d} )}^{8} x ( k ) + ( {( {A}_{d} )}^{4} + I ) ( {( {A}_{d} )}^{2} + I ) ( {A}_{d} + I ) {B}_{d} u ( k ) .$$

12. A vehicle comprising:
a sensor;
a vehicle plant; and
a processing system comprising:
a memory comprising computer readable instructions; and
a processing device for executing the computer readable instructions, the computer readable instructions controlling the processing system to perform operations for electronic control unit monitoring and horizon adaptation during vehicle control, the operations comprising:
receiving data from the sensor of the vehicle;
determining a reference trajectory for the vehicle and a control horizon;
segmenting a discretization step into a plurality of steps;
converting continuous-time dynamics to discrete-time dynamics for one step of the plurality of steps;
iterating over the plurality of steps to generate discretized dynamics for the discretization step;
using the discretized dynamics in a model predictive controller to generate desired steering commands for the vehicle; and
causing the vehicle plant to control the vehicle using the desired steering commands generated by the model predictive controller using the discretized matrix.

13. The vehicle of claim 12, wherein the operations further comprise dynamically adjusting the control horizon based on available computational resources of an electronic control unit of the vehicle.

14. The vehicle of claim 13, wherein dynamically adjusting the control horizon includes monitoring central processing unit utilization and task execution times.

15. The vehicle of claim 12, wherein the discretized dynamics for the discretization step are generated using a scaling and squaring approach.

16. The vehicle of claim 12, wherein the conversion from continuous-time dynamics to discrete-time dynamics for one step of the plurality of steps is generated using a bilinear transformation.

17. A computer program product comprising:
a set of one or more computer-readable storage media;
program instructions, collectively stored in the set of one or more storage media, for causing a processor set to perform computer operations for electronic control unit (ECU) resource utilization while controlling a vehicle, the operations comprising:
initiating prediction and control horizons using nominal values;
monitoring ECU resources;
determining if a rate of change of task execution at the ECU exceeds a first threshold;
determining if a rate of change of CPU utilization at the ECU exceeds a second threshold;
detecting if a CPU task overrun at the ECU is present;
reducing the prediction and control horizons to generate reduced prediction and control horizons responsive to a determination that any of the rate of change of task execution exceeds the first threshold, the rate of change of CPU utilization exceeds the second threshold, or the CPU task overrun is present;
determining if the reduced prediction and control horizons are below a minimum acceptable threshold;
responsive to determining that the reduced prediction and control horizons are not below the minimum acceptable threshold, continuing control operation; and
responsive to determining that the reduced prediction and control horizons are below the minimum acceptable threshold, requesting escalation.

18. The computer program product of claim 17, wherein reducing the prediction and control horizons comprises decrementing the prediction and control horizons by a predefined step size to generate the reduced prediction and control horizons.

19. The computer program product of claim 17, wherein requesting escalation comprises generating an alert to a vehicle operator indicating that manual intervention is required.

20. The computer program product of claim 17, wherein requesting escalation comprises implementing an alternative control strategy to control the vehicle.
